(19) United States
(12) Patent Application Publication
(10) Pub. No.: US 2024/0421549 A1
(43) Pub. Date: Dec. 19, 2024

(54) HIGH-POWER SINGLE-FREQUENCY PULSED LASER BASED ON INJECTION LOCKING TECHNOLOGY

(71) Applicant: SHANXI UNIVERSITY, Taiyuan (CN)

(72) Inventors: Huadong LU, Taiyuan (CN); Jiaqi SONG, Taiyuan (CN); Jiliang QIN, Taiyuan (CN); Kunchi PENG, Taiyuan (CN)

(21) Appl. No.: 18/675,177

(22) Filed: May 28, 2024

(30) Foreign Application Priority Data
Jun. 13, 2023 (CN) 202310699379.9

(51) Int. Cl. H01S 3/00; H01S 3/10; H01S 3/105; H01S 3/16

(52) U.S. Cl. CPC H01S 3/0014; H01S 3/10092; H01S 3/105; H01S 3/1666

(57) ABSTRACT

The present application discloses a high-power single-frequency pulsed laser based on an injection locking technology, including a pump light supply device, a seed light supply device, a slave laser, a light detector and a servo control system. The servo control system receives a probe signal outputted by the light detector and controls the cavity length of the slave laser according to an error signal extracted from the probe signal. The light detector has the characteristic of saturation current, and after the probe light enters the light detector, the pulse current becomes saturated and the modulated seed current becomes unsaturated. According to the present application, a light detector with pulse saturation current characteristics is adopted to effectively avoid the problem that the error signal cannot be obtained and it is difficult to achieve injection locking.

### TECHNICAL FIELD

The present application relates to the technical field of lasers, in particular to a high-power single-frequency pulsed laser based on an injection locking technology.

### BACKGROUND ART

With the continuous development of the laser technology, narrow linewidth lasers have been widely used in high precision spectroscopy, nonlinear spectroscopy, atmospheric optics, laser remote sensing, laser physics and laser chemistry, among other fields. Wherein high-power single-frequency pulsed lasers have become a research hotspot in recent years because of the advantages such as high average power and narrow linewidth. Many high-precision experiment researches, such as achieving resonance ionization spectroscopy and laser isotope separation in supersonic gas jets, require high-power pulsed lasers to have very narrow spectral width property. Although the insertion of a frequency selective element in a cavity can reduce the linewidth of the pulsed laser, it also increases the intracavity loss and reduces the power level. Once the peak power of the laser is too high, the frequency selective element may be damaged. In order to realize single frequency output of high-power pulsed lasers, an injection locking method is a better choice. In this method, a laser with narrow linewidth and low power is used as a active laser, and the seed light emitted by it is injected into a slave laser that can output high-power oscillating light. When the slave laser oscillates with the frequency of the seed laser, the free operation mode will be suppressed, and the laser with the same frequency as an active laser is output, that is, the slave laser is locked on the active laser, so as to achieve the purpose of single-frequency operation of laser. This technique not only simplifies the structure of the cavity and reduces the loss, but also lowers a laser output threshold and improves its laser output performance.

In order to generate an error signal required to lock the cavity length of a resonant cavity, a modulating signal needs to be loaded on the seed light. However, with the continuous increase of the output power of the developed pulsed laser, the output peak power reaches hundred megawatts or even higher. Compared with the pulsed oscillating light transmitted by the slave laser, the injected seed light power and the modulating signal loaded on the seed light are minimal and directly covered by pulsed laser, which makes it impossible to obtain the error signal to achieve the purpose of locking the cavity.

### SUMMARY OF THE INVENTION

The present application provides a high-power single-frequency pulsed laser based on an injection locking technology, which uses a light detector with pulse saturation current characteristics to effectively avoid the problem that the error signal cannot be obtained and it is difficult to achieve injection locking, due to the pulse light power being much greater than the seed light power and the modulation signal being minimal.

The present application provides a high-power single-frequency pulsed laser based on an injection locking technology, which includes a pump light supply device, a seed light supply device, a slave laser, a light detector and a servo control system.

The slave laser is arranged on an outgoing light path of the pump light supply device and the seed light supply device; the light detector is arranged on an outgoing light path of probe light outputted by the slave laser; and the servo control system receives a probe signal outputted by the light detector and controls the cavity length of the slave laser according to an error signal extracted from the probe signal.

The light detector has the characteristic of saturation current, and after the probe light enters the light detector, the pulse current becomes saturated and the modulated seed current becomes unsaturated.

Preferably, the light detector includes a photodiode, a trans-impedance amplifier and a first capacitor; an input signal of the photodiode is the probe light, and an output end of the photodiode is connected with an input end of the trans-impedance amplifier; a first output end of the trans-impedance amplifier is connected with the first end of the first capacitor; and a second end of the first capacitor outputs an AC signal to the servo control system.

Preferably, the light detector further includes a voltage follower, an input end of the voltage follower is connected with a second output end of the trans-impedance amplifier, and an output end of the voltage follower outputs a DC signal to the servo control system.

Preferably, the light detector further includes a secondary amplifier, an input end of the secondary amplifier is connected with an output end of the first capacitor, and an output end of the secondary amplifier outputs an AC signal to the servo control system.

Preferably, the slave laser adopts an L-shaped three-mirror standing-wave cavity, and an output concave mirror of the L-shaped three-mirror standing-wave cavity is provided with piezoelectric ceramics.

Preferably, the servo control system includes an error signal processor, a proportional-integral-differential controller, a control switch, a high-voltage amplifier and a first signal source.

An input signal of the error signal processor is an AC signal outputted by the light detector; an output end of the error signal processor is connected with an input end of the proportional-integral-differential controller; a first output end of the proportional-integral-differential controller is connected with a first input end of the control switch; an output end of the first signal source is connected with a second input end of the control switch; an output end of the control switch is connected with an input end of the high-voltage amplifier; and an output end of the high-voltage amplifier is connected with the piezoelectric ceramics.

Preferably, the servo control system further includes an oscilloscope; a first input end of the oscilloscope is connected with the output end of the voltage follower; and a second input end of the oscilloscope is connected with a second output end of the proportional-integral-differential controller.

Preferably, an adjustable attenuator for adjusting the probe light power is also arranged between the slave laser and the light detector.

Preferably, the probe light is emitted from the input concave mirror of the slave laser.

Preferably, the secondary amplifier is a reverse proportional amplifier, which further suppresses pulse current noise and amplifies the AC signal.

The secondary amplifier includes a first resistor, an amplifier, a second capacitor and a second resistor.

The amplifier, the second capacitor and the second resistor are connected in parallel to form a parallel part, and a positive input end of the amplifier is grounded.

A first end of the first resistor is connected with a second end of the first capacitor, a second end of the first resistor is connected with a first end of the parallel part, and a second end of the parallel part is the output end of the secondary amplifier.

Other features and advantages of the present application will become clear from the detailed description of exemplary embodiments of the present application with reference to the drawings below.

### BRIEF DESCRIPTION OF THE DRAWINGS

The drawings combined in the description and forming part of the description show embodiments of the present application, and are used to explain the principle of the present application together with the description.

FIG. 1 is a structural diagram of a high-power single-frequency pulsed laser based on an injection locking technology provided by the present application;

FIG. 2 is a circuit diagram of a light detector provided by the present application.

### DETAILED DESCRIPTION OF THE INVENTION

Various exemplary embodiments of the present application will now be described in detail with reference to the drawings. It should be noted that, unless otherwise specified, the relative arrangement, numerical expressions and numerical values of components and steps illustrated in these embodiments do not limit the scope of the present application.

The following description of at least one exemplary embodiment is actually illustrative only and in no way constitutes any limitation on the present application, application or use thereof.

Techniques, methods and equipment known to those ordinary skilled in the relevant art may not be discussed in detail, but if appropriate, the techniques, methods and equipment should be considered as part of the description.

In all examples shown and discussed here, any specific value should be interpreted as merely exemplary and not as a limitation. Therefore, other examples of exemplary embodiments may have different values.

The present application provides a high-power single-frequency pulsed laser based on an injection locking technology, which uses a light detector with pulse saturation current characteristics to effectively avoid the problem that the error signal cannot be obtained and it is difficult to achieve injection locking, due to the pulse light power being much greater than the seed light power and the modulation signal being minimal. Further, by adjusting the transmittance of the adjustable attenuator, the DC term outputted by the light detector is close to the saturation current, which increases the error signal while reducing a noise voltage signal caused by the pulse current, thereby improving a signal-to-noise ratio. Moreover, since the duty cycle of the pulse signal is usually very small, when the DC term is close to the saturation current, the noise introduced by the pulsed light can be ignored relative to the modulating signal.

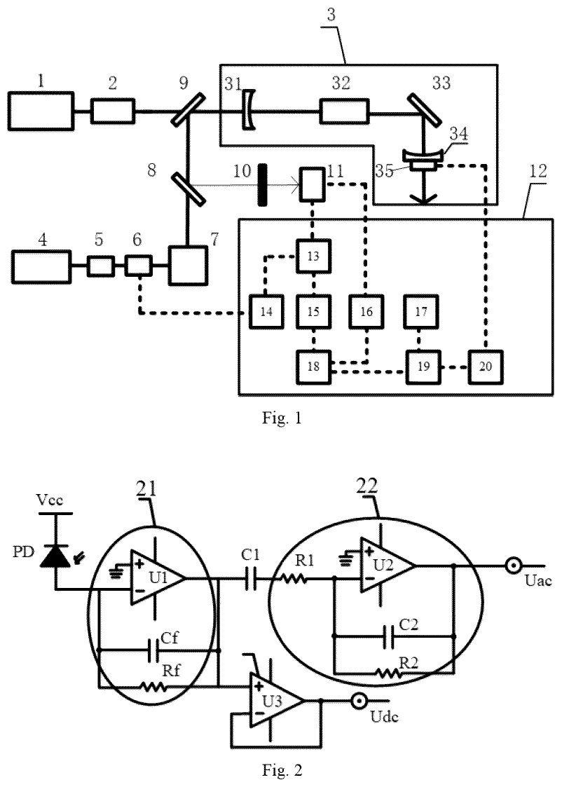

As shown in FIG. 1, a high-power single-frequency pulsed laser based on an injection locking technology provided by the present application includes a pump light supply device, a seed light supply device, a slave laser 3, a light detector 11 and a servo control system 12. The slave laser 3 is arranged on an outgoing light path of the pump light supply device and the seed light supply device; the light detector 11 is arranged on an outgoing light path of probe light outputted by the slave laser 3; and the servo control system 12 receives a probe signal outputted by the light detector 11. The probe signal is processed by the servo system to obtain an error signal which acts on piezoelectric ceramics 35 of the slave laser 3 to drive a cavity mirror at one end of a resonant cavity of the slave laser 3, so as to achieve the precise control of the cavity length of the slave laser 3. The light detector has the characteristic of saturation current, and after the probe light enters the light detector, the pulse current becomes saturated and the modulated seed current becomes unsaturated.

Specifically, the pump light supply device includes a pump laser 1 and a pump coupling device 2. The pump coupling device 2 is located on the outgoing light path of the pump laser 1, and the slave laser 3 is arranged on the outgoing light path of the pump coupling device 2. The pump light beam outputted by the pump laser 1 is shaped and focused by the pump coupling device 2 and then enters the slave laser 3 through a seed light high reflectivity mirror 9. Wherein the seed light high reflectivity mirror 9 is plated with a pump light high transparency film.

Optionally, the pump laser 1 is a solid-state laser, a fiber laser, a semiconductor laser or other lasers that can output high-power pulsed light.

The seed light supply device includes an active laser 4, an isolator 5, a phase modulator 6, and a light coupling device 7. The active laser 4 emits single-frequency seed light, the isolator 5 is located on the outgoing light path of the active laser 4, and the isolator 5 ensures one-way transmission of the seed light. The phase modulator 6 is located on the outgoing light path of the isolator 5, the phase modulator 6 loads a modulating signal for the emitted seed light, and a second signal source 14 in the servo control system 12 provides the modulating signal for the phase modulator 6. The seed light coupling device 7 is located on the outgoing light path of the phase modulator 6, and the seed light coupling device 7 shapes the seed light to match with the mode of the slave laser 3. On this basis, a seed light high transmittance mirror 8 and the seed light high reflectivity mirror 9 are located on the outgoing light path of the seed light coupling device 7, and the seed light shaped by the seed light coupling device 7 is transmitted through the seed light high transmittance mirror 8 and reflected by the seed light high reflectivity mirror 9, and then enters the slave laser 3. Wherein the seed light high transmittance mirror 8 simultaneously reflects the probe light emitted by the input concave mirror 31 into the light detector.

Optionally, the active laser 4 is a solid-state laser, a fiber laser, a semiconductor laser or other single-frequency lasers.

As an embodiment, the slave laser 3 is an optical parametric oscillator with an L-shaped three-mirror standing-wave cavity. As shown in FIG. 1, the slave laser 3 includes an input concave mirror 31, an LBO crystal 32, a flat mirror 33, and an output concave mirror 34. The LBO crystal 32 is arranged between the input concave mirror 31 and the flat mirror 33, and the output concave mirror 34 is bonded with the piezoelectric ceramics 35. Wherein the transmittance of the input concave mirror 31 is smaller than that of the output concave mirror 34. Changing the voltage of the piezoelectric ceramics 35 can change the cavity length of the resonant cavity of the slave laser 3, so as to realize the selection of an oscillation mode. Pump light is injected into the slave laser 3 to form oscillating light, and seed light injection is locked to form single-frequency high-power pulsed laser, which is outputted through the output concave mirror 34.

As an embodiment, the probe light formed by the slave laser 3 is emitted from the input concave mirror 31 of the slave laser 3.

Since the reflectance of the input concave mirror 31 is less than 100%, the oscillating light in the slave laser 3 may be transmitted from the input concave mirror 31, while only a small part of the seed light enters the slave laser 3, and most of the seed light is reflected by the input concave mirror 31. The seed light reflected from the input concave mirror 31 and the transmitted oscillating light merge into the probe light which is reflected onto the light detector 11 by the seed light high reflectivity mirror 9 and the seed light high transmittance mirror 8, and detected by the light detector 11 to convert a light signal into a current signal.

It can be understood that the resonant cavity of the slave laser 3 can also be a three-mirror cavity, a four-mirror cavity and other cavity types.

Optionally, the slave laser 3 can also be any high-power pulsed laser that requires a narrow line width, such as optical parametric oscillators based on nonlinear crystals or lasers based on gain crystals.

As shown in FIG. 2, the light detector 11 includes a photodiode PD, a trans-impedance amplifier 21, and a first capacitor C1, wherein the trans-impedance amplifier 21 is composed of a first amplifier U1, a third capacitor Cf, and a third resistor Rf. The input signal of the photodiode PD is the probe light outputted by the slave laser 3. The output end of the photodiode PD is connected with the input end of the trans-impedance amplifier 21, and the first output end of the trans-impedance amplifier 21 is connected with the first end of the first capacitor C1. The second end of the first capacitor C1 outputs an AC signal Uac to the servo control system 12. The AC signal is processed to form an error signal.

Preferably, as shown in FIG. 2, the light detector 11 further includes a voltage follower U3, an input end of the voltage follower U3 is connected with a second output end of the trans-impedance amplifier 21, and an output end of the voltage follower U3 outputs a DC signal Udc to the servo control system 12.

On the basis of the above, as shown in FIG. 2, the light detector 11 further includes a secondary amplifier 22 which is a reverse proportional amplifier to further suppress the pulse current noise and amplify the AC signal. The input end of the secondary amplifier 22 is connected with the output end of the first capacitor C1, and the output end of the secondary amplifier 22 outputs an AC signal to the servo control system 12.

As an embodiment, as shown in FIG. 2, the secondary amplifier 22 includes a first resistor R1, a second amplifier U2, a second capacitor C2, and a second resistor R2. The second amplifier U2, the second capacitor C2 and the second resistor R2 are connected in parallel to form a parallel part, wherein the positive input end of the second amplifier U2 is grounded. The first end of the first resistor R1 is connected with the second end of the first capacitor C1, and the second end of the first resistor R1 is connected with the first end of the parallel part (including the negative input of the second amplifier U2). The second end of the parallel part is the output end of the secondary amplifier 22, and is also the output end of the AC signal Uac of the light detector.

As an embodiment, the first amplifier U1 and the second amplifier U2 are both OPA855; the voltage follower U3 is OP27; the resistance value of the third resistor Rf is RF=5Ω; the capacity of the third capacitor Cf is CF=0.5 pF; the capacity of the first capacitor C1 is C1=1 nF; the resistance value of the first resistor R1 is R1=300Ω; the resistance value of the second resistor R2 is R2=5 kΩ; and the capacity of the second capacitor C2 is C2=0.5 pF.

Preferably, an adjustable attenuator 10 is also arranged between the slave laser 3 and the light detector 11. The adjustable attenuator 10 is used for controlling the power of the probe light that enters the light detector 11, to avoid damaging the photodiode by the pulsed light of high peak power, and to ensure that the seed light is unsaturated. By adjusting the transmittance of the adjustable attenuator 10, the DC term is close to the saturation current, which increases a modulating error voltage signal while reducing a noise voltage signal caused by the pulse current, thereby improving a signal-to-noise ratio.

The photodiode PD converts the received probe light into a current signal. The trans-impedance amplifier 21 converts the current signal into a voltage signal. The trans-impedance amplifier 21 has the characteristic of saturation current, which can perform voltage saturation treatment on the oscillating light with high peak power to reduce the influence on the extraction of the seed light modulating signal. At this time, the pulse current becomes saturated and the modulated seed light current becomes unsaturated, so significant trans-impedance gain and signal-to-noise ratio are obtained. The first capacitor C1 separates the DC signal and conducts the AC signal. The amplified AC voltage signal obtained after the trans-impedance amplifier 21 passes through the first capacitor C1. After passing through the secondary amplifier 22, the pulse signal is further saturated and the modulating signal is further amplified, thereby obtaining higher gain and signal-to-noise ratio. The resulting AC signal Uac is outputted from the light detector and then enters an error signal processor of the servo control system, to finally obtain the error signal. The DC voltage and a low-frequency signal that do not pass through the first capacitor C1 are outputted through the voltage follower U3; and the oscilloscope 16 receives the DC signal and then displays it as a linear waveform. By monitoring the elevating height of the DC signal of the oscilloscope 16, the adjustable attenuator 10 is adjusted to make the power of the probe light just close to saturation.

The servo control system 12 includes an error signal processor, a proportional-integral-differential controller PID 18, a control switch 19, a high-voltage amplifier 20 and a first signal source 17. The error signal processor includes a frequency mixer 13 and a low-pass filter 15 which are connected with each other. The input signal of the error signal processor is the AC signal outputted by the light detector, that is, the frequency mixer 13 is connected with the AC output end of the light detector 11, and also connected with the second signal source 14. The second signal source 14 provides a demodulation signal of the same frequency as the phase modulator 6 for the frequency mixer 13, and the frequency mixer 13 mixes the frequency of the AC signal and the demodulation signal. The output end of the error signal processor is connected with the input end of the PID 18, that is, the low-pass filter 15 is connected with the PID 18. The first output end of the PID 18 is connected with the first input end of the control switch 19; the output end of the first signal source 17 is connected with the second input of the control switch 19; the output end of the control switch 19 is connected with the input end of the high-voltage amplifier 20; and the output end of the high-voltage amplifier 20 is connected with the piezoelectric ceramics 35.

Preferably, the servo control system 12 further includes an oscilloscope 16. and a first input end of the oscilloscope 16 is connected with the output end of the voltage follower U3, that is, the oscilloscope 16 is connected with a DC output end of the light detector 11. A second input end of the oscilloscope 16 is connected with the second output end of the PID 18.

The AC signal measured by the light detector 11 passes through the frequency mixer 13 and the low-pass filter 15 to obtain an error signal which is inputted into the PID 18. The second output end of the PID 18 inputs the error signal into the oscilloscope in real time, to form a frequency discrimination curve indicating the error signal, which is displayed on the oscilloscope 16. When the control switch 19 is in a scanning state, the high-voltage amplifier 20 is provided with a modulating signal by the first signal source 17 to drive the piezoelectric ceramics 35 to scan the cavity length in a large range. By adjusting the amplitude and phase of the modulating signal provided by the second signal source 14, the frequency discrimination curve is optimized. When the amplitude of the frequency discrimination curve at a central resonance frequency is 0 and the curve is odd symmetry, and its slope is also large, the working mode of the servo control system 12 is switched, so that the control switch 19 is in a locked state. The high-voltage amplifier 20 is provided with the modulating signal by the first output end of the PID 18. Through the feedback information of the error signal, the cavity length is scanned in a small range near a resonance point, and the cavity length of the resonant cavity of the slave laser 3 is stably locked at the seed light frequency resonance point. At this time, the single-frequency high-power pulsed laser is outputted.

The working principle of the high-power single-frequency pulsed laser provided by the present application is as follows:

The high-power pulsed pump light emitted by the pump laser 1 is injected into the slave laser 3 to generate high-power pulsed oscillating light. When the resonant cavity of the slave laser 3 is operated freely, dozens of watts of high-power pulsed oscillating light is outputted, which has spectral width of over ten nanometers. The single-frequency seed light outputted by the active laser 4 is loaded a modulating signal through the phase modulator 6 and is injected into the slave laser 3. When the resonant cavity is oscillated at the seed light frequency, the high-power single-frequency pulsed laser output with the same frequency as the seed light can be obtained. The light detector 11 detects the probe light reflected by the input concave mirror 31 and extracts the error signal. However, when the seed light is injected into the slave laser 3 through the input concave mirror 31, the oscillating light will also be transmitted from the resonant cavity through the input concave mirror 31. Because the power of the transmitted oscillating light is much larger than the power of the seed light, and the modulating signal is small, it is difficult to extract the error signal. In order to reduce the influence of the oscillating light on the extraction of the error signal, the input concave mirror 31 is selected as an injection coupling mirror of the seed light. This is because the transmissivity of the output concave mirror 34 of the slave laser 3 to the oscillating light is greater than that of the input concave mirror 31. Therefore, a transmitted light field of the input concave mirror 31 has a higher signal-to-noise ratio than the error signal extracted from a transmitted light field of the output concave mirror 34. On this basis, combined with the saturation current characteristics of the trans-impedance amplifier in the light detector 11, the DC term is close to the saturation current by adjusting the transmittance of the adjustable attenuator 10, which can not only increase the error voltage signal, but also reduce the noise voltage signal caused by the pulse current, so as to improve the signal-to-noise ratio. Since the duty cycle of the pulse signal is usually very small, when the DC term is close to the saturation current, the noise introduced by the pulsed light can be ignored relative to the modulating signal. After the AC signal outputted from the light detector is processed by the servo control system, then the error signal is extracted, and the cavity length of the slave laser 3 is adjusted by feedback to achieve injection locking, so as to output the high-power single-frequency pulsed laser with stable frequency.

Based on the above, the present application is easy to output the single-frequency pulsed light with higher power and higher stability, which has higher practical value. The present application is suitable for laser devices that need to produce high-power single-frequency pulsed light but whose frequency selective elements cannot withstand high peak power laser.

Although some specific embodiments of the present application have been elaborated by examples, it should be understood by those skilled in the art that the above examples are for illustration only and not to limit the scope of the present application. It should be understood by those skilled in the art that the above embodiments may be modified without deviating from the scope and spirit of the present application. The scope of the present application is defined by the attached claims.

1. A high-power single-frequency pulsed laser based on an injection locking technology, comprising a pump light supply device, a seed light supply device, a slave laser, a light detector and a servo control system;
wherein the slave laser is arranged on an outgoing light path of the pump light supply device and the seed light supply device; the light detector is arranged on an outgoing light path of probe light outputted by the slave laser;
and the servo control system receives a probe signal outputted by the light detector and controls the cavity length of the slave laser according to an error signal extracted from the probe signal;
the light detector has the characteristic of saturation current, and after the probe light enters the light detector, the pulse current becomes saturated and the modulated seed current becomes unsaturated.

2. The high-power single-frequency pulsed laser based on the injection locking technology according to claim 1, wherein the light detector comprises a photodiode, a trans-impedance amplifier and a first capacitor; an input signal of the photodiode is the probe light, and an output end of the photodiode is connected with an input end of the trans-impedance amplifier; a first output end of the trans-impedance amplifier is connected with the first end of the first capacitor; and a second end of the first capacitor outputs an AC signal to the servo control system.

3. The high-power single-frequency pulsed laser based on the injection locking technology according to claim 2, wherein the light detector further comprises a voltage follower, an input end of the voltage follower is connected with a second output end of the trans-resistance amplifier, and an output end of the voltage follower outputs a DC signal to the servo control system.

4. The high-power single-frequency pulsed laser based on the injection locking technology according to claim 2, wherein the light detector further comprises a secondary amplifier, an input end of the secondary amplifier is connected with an output end of the first capacitor, and an output end of the secondary amplifier outputs an AC signal to the servo control system.

5. The high-power single-frequency pulsed laser based on the injection locking technology according to claim 3, wherein the slave laser adopts an L-shaped three-mirror standing-wave cavity, and an output concave mirror of the L-shaped three-mirror standing-wave cavity is provided with piezoelectric ceramics.

6. The high-power single-frequency pulsed laser based on the injection locking technology according to claim 5, wherein the servo control system comprises an error signal processor, a proportional-integral-differential controller, a control switch, a high-voltage amplifier and a first signal source;
an input signal of the error signal processor is an AC signal outputted by the light detector; an output end of the error signal processor is connected with an input end of the proportional-integral-differential controller; a first output end of the proportional-integral-differential controller is connected with a first input end of the control switch; an output end of the first signal source is connected with a second input end of the control switch; an output end of the control switch is connected with an input end of the high-voltage amplifier; and an output end of the high-voltage amplifier is connected with the piezoelectric ceramics.

7. The high-power single-frequency pulsed laser based on the injection locking technology according to claim 6, wherein the servo control system further comprises an oscilloscope; a first input end of the oscilloscope is connected with the output end of the voltage follower; and a second input end of the oscilloscope is connected with a second output end of the proportional-integral-differential controller.

8. The high-power single-frequency pulsed laser based on the injection locking technology according to claim 5, wherein an adjustable attenuator for adjusting the probe light power is also arranged between the slave laser and the light detector.

9. The high-power single-frequency pulsed laser based on the injection locking technology according to claim 8, wherein the probe light is emitted from the input concave mirror of the slave laser.

10. The high-power single-frequency pulsed laser based on the injection locking technology according to claim 4, wherein the secondary amplifier comprises a first resistor, an amplifier, a second capacitor and a second resistor;
the amplifier, the second capacitor and the second resistor are connected in parallel to form a parallel part, and a positive input end of the amplifier is grounded;
a first end of the first resistor is connected with a second end of the first capacitor, a second end of the first resistor is connected with a first end of the parallel part, and a second end of the parallel part is the output end of the secondary amplifier.

11. The high-power single-frequency pulsed laser based on the injection locking technology according to claim 3, wherein the light detector further comprises a secondary amplifier, an input end of the secondary amplifier is connected with an output end of the first capacitor, and an output end of the secondary amplifier outputs an AC signal to the servo control system.

12. The high-power single-frequency pulsed laser based on the injection locking technology according to claim 11, wherein the secondary amplifier comprises a first resistor, an amplifier, a second capacitor and a second resistor;
the amplifier, the second capacitor and the second resistor are connected in parallel to form a parallel part, and a positive input end of the amplifier is grounded;
a first end of the first resistor is connected with a second end of the first capacitor, a second end of the first resistor is connected with a first end of the parallel part, and a second end of the parallel part is the output end of the secondary amplifier.
